(19) United States
(12) Patent Application Publication
(10) Pub. No.: US 2026/0257157 A1
(43) Pub. Date: Sep. 3, 2026

(54) WASHING MACHINE EFFLUENT FILTRATION WITH AN AGITATOR ROTATING AROUND A FILTER ELEMENT

(71) Applicant: MANN+HUMMEL Life Sciences & Environment Holding Singapore Pte. Ltd., Singapore (SG)

(72) Inventors: Sonia LORENTE, Zaragoza (ES); Laura DEL RIO, Longares (ES); Ignacio ESTEBAN, ZARAGOZA (ES); Jaime GRACIA HERAS, Zaragoza (ES); Raúl BIELSA, Zaragoza (ES); Leopoldo MARZAL, Zaragoza (ES)

(21) Appl. No.: 19/657,095

(22) Filed: Apr. 24, 2026

Related U.S. Application Data
(63) Continuation of application No. PCT/IB2024/060350, filed on Oct. 22, 2024.

(30) Foreign Application Priority Data
Nov. 8, 2023 (EP) 23383144

(51) Int. Cl. B01D 29/86; B01D 29/15; B01D 29/68; B01D 36/04; C02F 1/00; C02F 1/38; D06F 39/10

(52) U.S. Cl. CPC B01D 29/86; B01D 29/15; B01D 29/68; B01D 36/045; C02F 1/001; C02F 1/38; D06F 39/10; B01D 2201/0415; B01D 2201/291; B01D 2201/4092; C02F 2303/16; C02F 2307/12

(57) ABSTRACT

A rotor assisted filter for filtering effluent of a washing machine wherein rotation of the rotor supports centrifugal separation of especially heavier particles and fibres. A filter element engages into the rotor between blades of the rotor. The filter element may separate microplastics from the effluent. A receptacle surrounds the filter element. Fibres, particles and microplastics are collected in the receptacle. For cleaning, the filter element and the receptacle may be removed from a filter housing. The receptacle is detachable from the filter element and sliding the receptacle along the filter element may wipe debris from the filter element.

### CROSS-REFERENCE TO RELATED APPLICATIONS

This application is a continuation application of international application No. PCT/IB2024/060350 having an international filing date of October 22, 2024, and designating the United States, the international application claiming a priority date of November 8, 2023, based on European patent application No. 23383144.5, the entire contents of the aforesaid applications being incorporated herein by reference to the fullest extent permissible.

### TECHNICAL FIELD

The present invention refers to a filter assembly comprising:

a housing;

a filter element; and

a rotor, rotatably mounted inside the housing and including at least one blade.

### BACKGROUND

Such a filter assembly is known from the article “Filtersysteme für den Einsatz in anspruchsvollen Anwendungen – Auf den Prozess abgestimmt”, published online at https://prozesstechnik.industrie.de/chemie/schuettguttechnik-chemie/auf-den-prozess-abgestimmt/ on 07.06.2022, last accessed on 29.09.2023.

When clothing is being washed, fibers and debris are released. Since clothing is often made with synthetic fibers, a certain amount of microplastics is generated during each washing cycle. Nowadays, microplastics emission is frequently considered as a severe ecological problem.

If the fibers and microplastics shall not be released into the environment, they need to be held back in order to be suitably disposed of. To this end, the use of filters is generally known, for instance from WO 2021/070102 A1.

The article cited at the outset describes a filter element for filtration of process fluids from industrial plants, wherein dynamic scrapers move around the filter element, which additionally rotate the liquid to be filtered. Due to the centrifugal forces, the dirt particles are transported from the filter element towards a housing wall and continuously discharged downwards. The hydrodynamic scrapers also generate negative pressure forces and thus unstable flow conditions at the surface of the filter element. This enhances the filtration effect. Both effects together prevent the formation of filter cakes on the filter surface.

WO 2021/070102 A1 discloses a filter assembly including an inertial separator as a first filter stage for removing the largest and heaviest particles. The inertial separator is formed of a tangential inlet and cylindrical inside walls of a vessel which cause the incoming effluent to rotate, throwing larger debris to the outside of the vessel under centrifugal force where the debris sinks to the bottom of the vessel. A second filter stage of the filter assembly includes a cylindrical coarse mesh.

It is an object of the invention to provide an efficient and easy to clean filter for effluent of washing machines.

This is achieved by a filter assembly according to the invention, the use of a filter assembly according to the invention and a washing machine according to the invention. Embodiments are given in the following description in conjunction with the accompanying drawings.

In accordance with the invention, a filter assembly, for filtering effluent of a washing machine is provided. The effluent may also be referred to as wastewater. The effluent generally includes dirt, having been washed out from clothing and the like, and material of the clothing, for example fibers and debris, which may contain microplastics.

The filter assembly includes a housing. An inlet, for the effluent from a drum of the washing machine, is typically arranged at an upper end of the housing. An outlet for filtered wastewater, i.e., wastewater containing less fibers and particles than the effluent from the drum, is typically arranged at a lower end of the housing.

The filter assembly further includes a filter element, having a cylindrical filter medium body. For example, the filter medium body is a filter mesh. A maximum pore size of the filter medium body may be 150 µm, or 100, for example 50, particularly for example 20 µm. The filter element prevents particles such as microplastics from advancing to the outlet. During use, water passes through the filter medium body towards the radial inside.

A rotor of the filter assembly is rotatably mounted inside the housing. The rotor may also be referred to as an agitator. The rotor includes at least one blade extending along the filter element. The blade may run parallel or inclined with respect to an axis of rotation of the rotor. Typically, the rotor includes at least 2 blades. The rotor may include for example 4 or 5 blades. The blades may all have the same cross-sectional shape. Alternatively, at least one of the blades may have a cross-sectional shape, which differs from the cross-sectional shape of at least one other blade.

During use of the filter assembly, the rotor rotates around the filter medium body. The rotation of the rotor causes the effluent to rotate inside the housing. Due to centrifugal forces, part of the particles travel to a circumferential wall of the housing. These particles generally sink downwards along the circumferential housing wall. The rotating blades may further create pressure waves and/or locally alternating flow directions, for example towards the radial inside or outside. This contributes to permanently clean the filter medium body and to prevent it from clogging.

The axis of rotation of the rotor generally coincides with the axis of the filter medium body. Indications of directions such as radial, axial or circumferential generally refer to the axis of rotation, the common axis. During use, the axis of rotation, the common axis, is oriented approximately vertically, for instance with a maximum inclination towards a vertical axis of at most 20°, for example at most 10°.

According to the invention, the filter assembly includes a receptacle, which is located at a bottom end of the filter element. The receptacle serves to collect particles, which have been separated from the effluent water via centrifugal forces and by the filter element.

For example, the receptacle engages around the filter element. The receptacle may be cup-shaped and include an outer wall and a lower face. The receptacle may be rotationally symmetric with respect to the axis of the filter element. The receptacle is typically arranged above the outlet of the housing.

Further according to the invention, the filter element and the receptacle are detachably arranged inside the housing. This allows the filter element and the receptacle to be removed from the housing for cleaning. With the filter element and the receptacle separated from the housing, an accumulation of dirt containing microplastics and the like may be wiped out of the receptacle and suitably disposed. After cleaning, the filter element and the receptacle are reinstalled in the housing for further use of the filter assembly.

Besides the inlet and the outlet, the housing is generally closed during use of the filter assembly. For example, no dirt outlet is provided at the housing. Rather, the particles, fibers and the like are collected in the receptacle and are disposed during maintenance, as described beforehand.

The filter element may include a support body, around which the filter medium body engages. The support body provides stability to the filter medium body. For example, the support body includes longitudinal and circumferential ribs. This design keeps a large area of the filter medium body open for filtration while providing sufficient stability.

The support body may include an end plate, which seals the housing in the assembled state. This design reduces the number of parts to be handled during maintenance. For example, no separate cover for the housing needs to be provided, since the end plate of the support body serves to close an insertion opening of the housing. For example, the end plate and the housing include mating threads. This facilitates assembly and disassembly, while assuring a secure connection. A seal element, such as an O-ring, may be arranged between the housing and the end plate. Thereby, the risk of leakage is further reduced.

The support body may have a shoulder for sealing abutment with the receptacle, for example of a lower face of the receptacle. The shoulder defines the position of the receptacle in the installed state. Further, the shoulder facilitates sealing the receptacle against the support body, in order to prevent water containing debris from bypassing between the receptacle and the filter element.

The support body may have flow openings (flow windows) arranged below the shoulder. The flow openings allow filtered water from the radial inside of the filter medium body to be discharged towards an outlet. The flow openings may for example be provided between the shoulder and the end plate.

In an embodiment, the receptacle is detachable from the filter element. This allows the receptacle to be removed from the filter element for cleaning.

The receptacle may be slidable along the filter element, for example with an inner edge of the receptacle abutting the filter element. An intuitive sliding motion may be applied without tools for disassembly and assembly. Further, the inner edge of the receptacle sliding along the filter element scrapes debris from the filter medium body during disassembly. Thus, thorough cleaning is achieved with few, simple manipulations. For example, the inner edge is provided at a lower face of the receptacle, which lower face may sealingly abut with a shoulder of the support body in the mounted state.

The housing may have an inwardly protruding rim for sealing abutment of an upper edge of an outer wall of the receptacle. This prevents water containing debris from bypassing between the housing and the receptacle. Further, the rim provides an upper stop for the receptacle. For example, the receptacle may be clamped between the rim of the housing and the shoulder of the support body in the assembled state. Thus, mispositioning of the receptacle is reliably prevented.

The rotor may have a shaft, which protrudes through an upper end wall of the housing. For example, the shaft is rotatably mounted at the upper end wall. A standard bearing or bushing may be employed with this design. Further, the protruding shaft facilitates attachment of a motor for driving the rotor.

The filter assembly may further include a motor, for example an electric motor, for rotating the rotor. For example, the motor is attached to the protruding shaft of the rotor. The motor allows driving the rotor independently of a pump of the washing machine. In other words, a certain rotational speed of the rotor may be obtained, irrespective of the water flow rate through the washing machine.

At least one of the blades of the rotor may have a tapered cross section. For example, a radial width of the blade decreases in circumferential direction over at least half of the circumferential extension of the blade. For example, the blade may be provided with an airfoil profile. The tapered cross section of the rotating blade creates varying pressure and/or flow directions traveling around the filter medium body when the rotor rotates. In other words, waves may be created in the water. For instance, a radially inward flow pattern may establish at a front edge of the blade, while a radially outward flow pattern establishes at a rear edge of the blade. This contributes to prevent clogging of the filter medium body and to remove fibers or particles from the filter medium body.

At least one of the blades of the rotor may have a cross section of constant radial width. This design may save manufacturing costs.

For example, blades of different cross sections are provided at the rotor. Thus, different flow patterns arise, which may result in efficient cleaning and clogging prevention for the filter element during regular use.

The rotor may include a flange with at least one axially inclined rib. For example, several inclined ribs are provided at the flange. The flange is generally arranged adjacent to the receptacle in the assembled state. Upon rotation of the rotor, the at least one inclined rib, which may also be referred to as a sloping edge, pushes the water downward into the receptacle. In other words, the flange with the at least one inclined rib acts as an axial fan.

The inclined rib(s) for example protrude radially outwardly at the flange. Thus, a downward flow pattern is established for example, adjacent to a circumferential housing wall, where heavier particles accumulate due to centrifugal forces.

The invention also relates to the use of a filter assembly according to the invention, as described above, for filtering effluent of a washing machine. Thereby, the ecological impact of operating the washing machine may be reduced.

The invention further relates to a washing machine including a filter assembly according to the invention, as described above. During operation of the washing machine, less particles, such as microplastics, are fed into a sewage system. The washing machine typically includes a water inlet for receiving clean water, a washing drum, and a water outlet for discharging wastewater. For example, the filter assembly is fluidically arranged between the washing drum and the water outlet. In other words, effluent of the washing drum is directed through the filter assembly prior to being dischargeed via the water outlet.

### BRIEF DESCRIPTION OF THE DRAWINGS

Other advantages and features of the invention will be appreciated from the following description of embodiments of the invention with reference to the accompanying drawing figures, which show significant details, and from the appended claims. The individual features, as described above or explained below, may each be implemented individually or implemented together in any useful combination in variants of the invention.

FIG. 1 shows a washing machine according to the invention comprising a filter assembly according to the invention, in a schematic sketch.

FIG. 2 shows a filter assembly according to the invention, in a schematic perspective view.

FIG. 3 shows the filter assembly from FIG. 2 in a schematic longitudinal section.

FIG. 4 shows the filter assembly from FIG. 2 with a filter element and a receptacle removed from a housing, in a schematic partly sectional view.

FIG. 5 shows the filter element of the filter assembly from FIG. 2, while the receptacle is being removed, in a schematic perspective view.

FIG. 6 shows a rotor of the filter assembly from FIG. 2, in a schematic perspective view.

FIG. 7 shows the rotor from FIG. 6 in a schematic sectional view.

### DETAILED DESCRIPTION

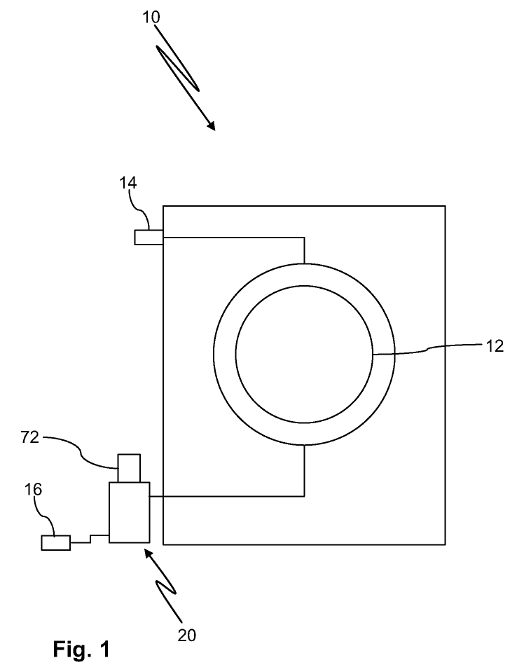

FIG. 1 shows a washing machine 10. The washing machine 10 comprises a rotatable drum 12 for receiving clothing or the like to be washed. Fresh water is fed into the drum 12 via a water inlet 14 of the washing machine 10. Wastewater (effluent) from the drum 12 is discharged into a sewage system (not depicted) via a water outlet 16 of the washing machine 10. Fluidically between the drum 12 and the water outlet 16 a filter assembly 20 is arranged. The filter assembly 20 may be arranged outside of the washing machine 10, as depicted in FIG. 1, or may be arranged within a housing of the washing machine 10 (not depicted). The filter assembly 20 prevents debris, which may contain microplastics, from being discharged into the sewage system.

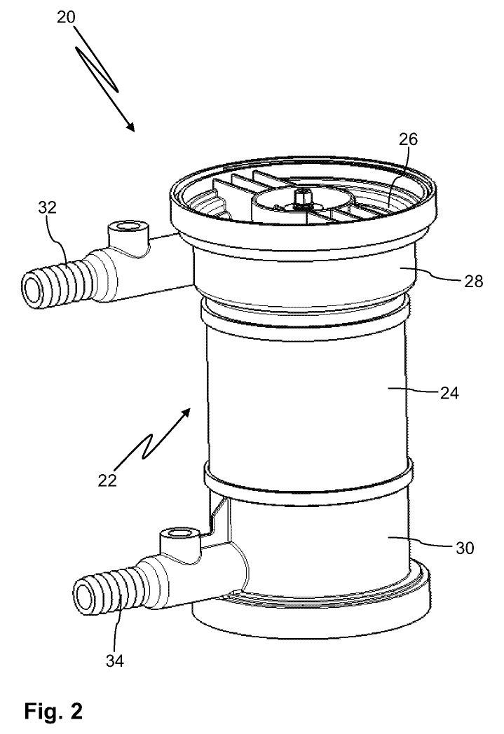

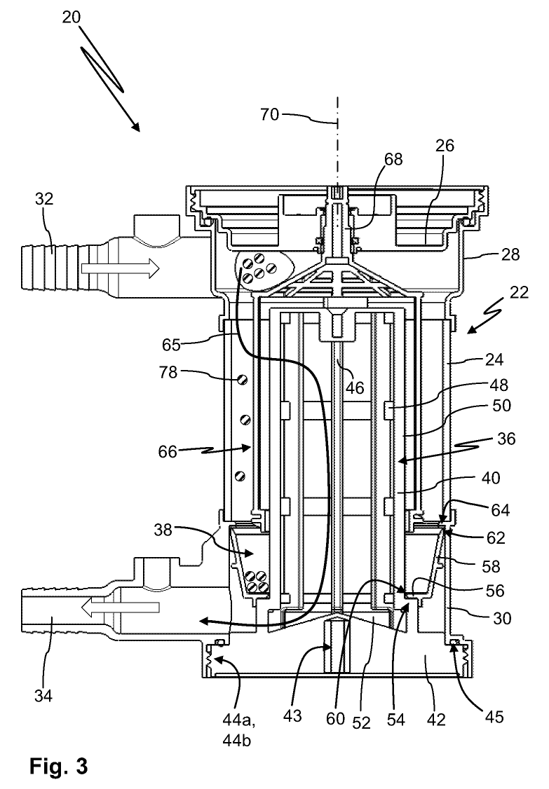

FIG. 2 and FIG. 3 show the filter assembly 20 of the washing machine 10. The filter assembly 20 comprises a housing 22, which has a cylindrical circumferential wall 24. In the depicted embodiment, an upper end wall 26 of the housing 22 is screwed into an upper housing part 28, which in turn is connected to an upper end of the circumferential wall 24. A lower housing part 30 is connected to a lower end of the circumferential wall 24. An inlet 32 of the filter assembly 20 is formed at the upper housing part 28. The inlet 32 directs fluid flow tangentially into the housing 22, such that an initial centrifugal force of the wastewater is generated. The wastewater may rotate at least partially around and outside a filter medium body 50 under the initial centrifugal force. The initial centrifugal force is supplemented by the rotation of a rotor 66 described further below. An outlet 34 of the filter assembly 20 is formed at the lower housing part 30.

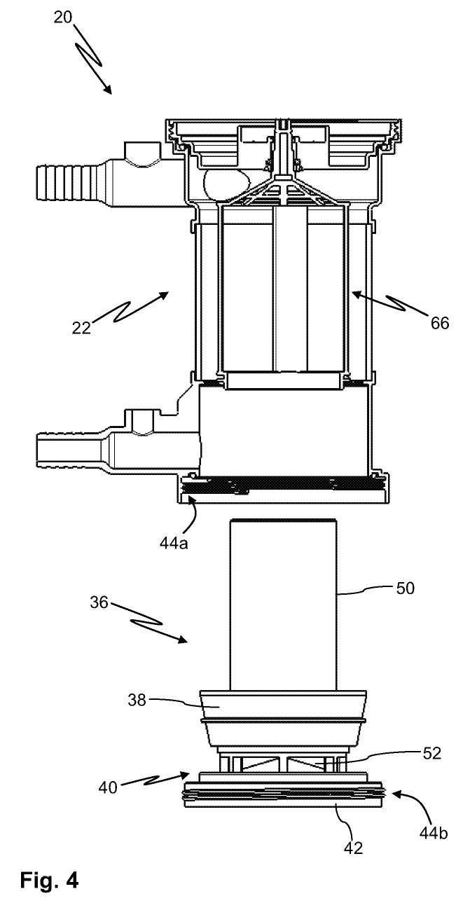

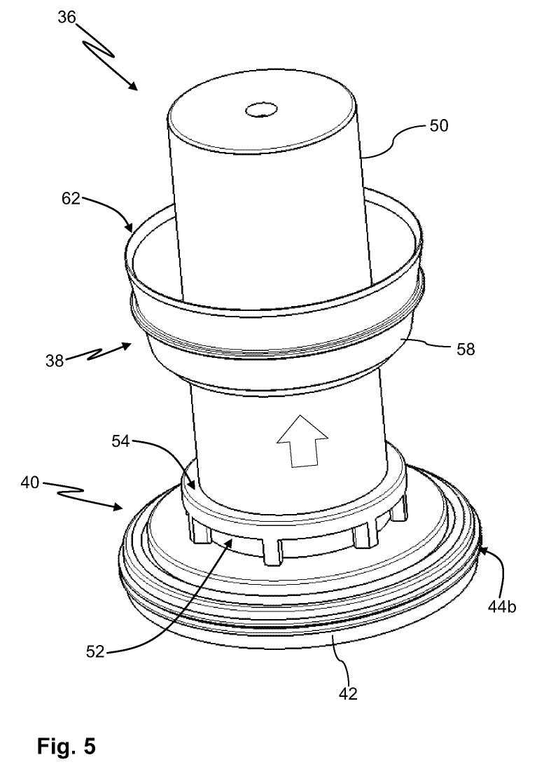

A filter element 36 and a receptacle 38 are detachably mounted in the housing 22, see also FIG. 4. The receptacle 38 is detachably arranged on the filter element 36, see also FIG. 5.

The filter element 36 comprises a support body 40, see for example FIG. 3. The support body 40 has an end plate 42, which in the assembled state closes the housing 22 at its lower end. The end plate 42 and the lower housing part 30 comprise mating threads 44a, 44b to establish a detachable connection. A seal element 45 may be arranged between the end plate 42 and the lower housing part 30. The end plate 42 may be provided with a tool interface 43 or with a grip (not depicted) for toolfree disassembly and assembly.

A grid section of the support body 40 axially projects from the end plate 42 into the housing 22. The grid section compises longitudinal and circumferential ribs 46, 48. The cylindrical filter medium body 50 made from filter mesh encompasses the grid section.

Between the grid section and the end plate 42 of the support body 40, flow openings 52 are formed. Through the flow openings 52 a fluid connection between the clean side, i.e. the radially inner volume of the filter medium body 50 and the outlet 34 is established.

A circumferential shoulder 54 is formed between the flow openings 52 and the grid section. In the assembled state, the receptacle 38 rests on the shoulder 54.

The receptacle 38 is rotationally symmetric and comprises a lower face 56 and an outer wall 58, which projects from the lower face 56 and expands upwardly.

The lower face 56 of the receptacle 38 sealingly abuts the support body 40. For example, an inner edge 60 of the lower face 56 closely fits around the support body 40 and the filter medium body 50. When the receptacle 38 is being removed from the filter element 36 during maintenance, see FIG. 5, the inner edge 60 scrapes particles and fibers from the filter medium body 50. These residues are automatically collected in the receptacle 38, while it is slid along the filter medium body 50.

In the assembled state, an upper edge 62 of the outer wall 58 sealingly abuts an inwardly projecting rim 64 of the housing 22.

Thus, by its contact with the housing 22 and the support body 40, the receptacle 38 prevents direct fluid flow from the inlet 32 to the outlet 34. Rather, the water is forced to pass through the filter medium body 50, which prevents fibres, particles and for example microplastics from passing through. This flow path is indicated in FIG. 3 by an arrow 65.

The filter assembly 20 further comprises a rotor 66. The rotor 66 is mounted inside the housing 22 and engages around the filter medium body 50. A shaft 68 of the rotor 66 projects through the upper end wall 26 of the housing 22. Seals and bearings or bushings may be provided between the shaft 68 and the upper end wall 26. An axis of rotation of the rotor 66 conicides with an axis of the cylindrical filter medium body 50; the common axis is labeled with numeral 70. A motor 72 for rotating the rotor 66 may be attached to the free end of the shaft 68, see FIG. 1.

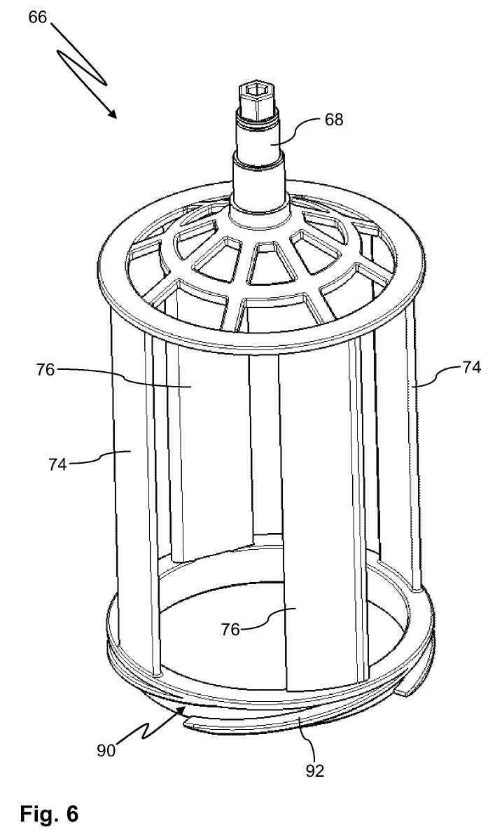

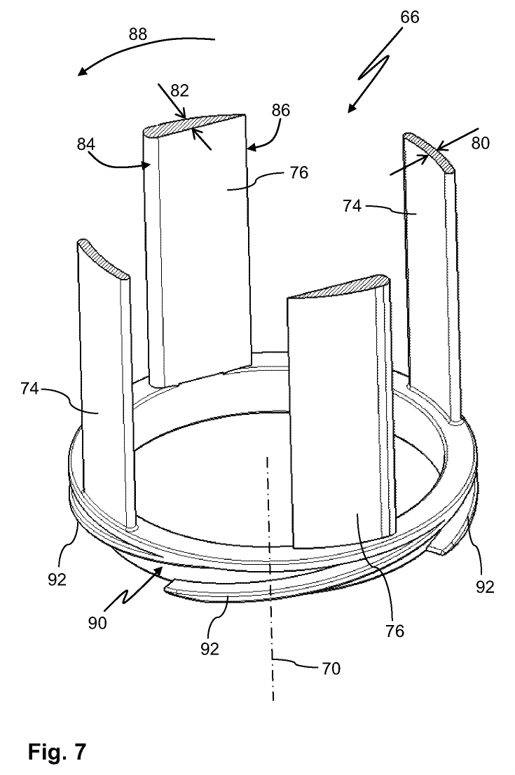

The rotor 66 serves to assist in separating particles from the wastewater, which is received via the inlet 32. Further, the rotor 66 serves to prevent the filter medium body from clogging. The rotor 66 comprises several blades 74, 76 extending along the filter medium body 50, see for example FIG. 6 and FIG. 7. In this embodiment, the blades 74, 76 extend parallel to axis 70.

During operation, the rotating blades 74, 76 make the water outside the filter medium body 50 rotate around axis 70. This causes especially heavier particles 78 to travel towards the circumferential wall 24, where they sink into the receptacle 38, see FIG. 3. Note that the size of the particles 78 is exaggerated in FIG. 3.

In the depicted embodiment, two blades 74 have a constant radial width 80, see FIG. 7.

Two blades 76 have a tapered cross section, which may resembes an airfoil. A radial width 82 of the blades 76 decreases from their front edges 84 towards their rear edges 86. An arrow indicates the direction of rotation 88 of the rotor 66.

At the front edges 84 of the blades 76, the rotation of the rotor 66 supports an inward flow of water through the filter medium body 50. At the rear edges 86, the rotation of the rotor 66 causes a local reversal of the flow pattern, i.e. water may be sucked back outwardly. By this local backflush, particles and fibers that may be stuck in the filter medium body 50 may be freed, so they may sink into the receptacle 38.

At the lower end of the rotor 66 a circumferential flange 90 is provided. The blades 74, 76 are each connected to the flange 90. The flange 90 has outwardly projecting ribs 92 (which may also be referred to as blades), which are inclined against the axis 70. When the rotor 66 rotates, the axially inclined ribs 92 push water and debris into the receptacle 38. Since the receptacle 38 is open towards the filter medium body 50, water may pass from the receptacle 38 through the filter medium body 50, while debris is kept in the receptacle 38.

In summary, the invention refers to a rotor assisted filter for filtering effluent of a washing machine. Rotation of the rotor supports centrifugal separation of especially heavier particles and fibres. A filter element engages into the rotor, for example between axially extending blades of the rotor. The filter element may separate microplastics from the effluent. A receptacle surrounds the filter element. Fibres, particles and microplastics are collected in the receptacle. For cleaning, the filter element and the receptacle may be removed from a filter housing. For example, the receptacle is detachable from the filter element. Sliding the receptacle along the filter element may wipe debris from the filter element.

### REFERENCE CHARACTERS

Washing machine 10

Drum 12

Water inlet 14

Water outlet 16

Filter assembly 20

Housing 22

Circumferential wall 24

Upper end wall 26

Upper housing part 28

Lower housing part 30

Inlet 32

Outlet 34

Filter element 36

Receptacle 38

Support body 40

End plate 42

Threads 44a, 44b

Seal element 45

Longitudinal ribs 46

Circumferential ribs 48

Filter medium body 50

Flow openings 52

Shoulder 54

Lower face 56

Outer wall 58

Inner edge 60

Upper edge 62

Rim 64

Arrow 65

Rotor 66

Shaft 68

Axis 70

Motor 72

Blades 74, 76

Particles 78

Radial width 80, 82

Front edge 84

Rear edge 86

Direction of rotation 88

Flange 90

Inclined ribs 92

That which is claimed is:

1. A filter assembly, comprising:
a housing;
a filter element having a cylindrical filter medium body;
a rotor, rotatably mounted inside the housing and comprising at least one blade; and
a receptacle, located at a bottom end of the filter element;
wherein the filter element and the receptacle are detachably arranged inside the housing.

2. The filter assembly according to claim 1, wherein the filter element comprises a support body, around which the filter medium body engages, and wherein the support body comprises longitudinal and circumferential ribs.

3. The filter assembly according to claim 2, wherein the support body comprises an end plate, which seals the housing in an assembled state, and wherein the end plate and the housing comprise mating threads.

4. The filter assembly according to claim 2, wherein the support body has a shoulder for sealing abutment with the receptacle.

5. The filter assembly according to claim 4, wherein the support body comprises flow openings arranged below the shoulder .

6. The filter assembly according to claim 5, wherein the receptacle is configured for being detachable from the filter element .

7. The filter assembly according to claim 6, wherein the receptacle is slidable along the filter element with an inner edge of the receptacle abutting the filter element.

8. The filter assembly according to claim 1, wherein the housing has an inwardly protruding rim for sealing abutment with an upper edge of an outer wall of the receptacle.

9. The filter assembly according to claim 1, wherein the rotor has a shaft, which protrudes through an upper end wall of the housing.

10. The filter assembly according to claim 9, further comprising a motor for rotating the rotor, and wherein the motor is attached to a protruding shaft of the rotor.

11. The filter assembly according to claim 10, wherein the rotor comprises a plurality of blades and at least one of the blades has a tapered cross section, and wherein a radial width of the at least one blade decreases in circumferential direction over at least half of the circumferential extension of the at least one blade.

12. The filter assembly according to claim 11, wherein at least another one of the plurality of blades has a cross section of a constant radial width.

13. The filter assembly according to claim 9, wherein the rotor comprises a flange with at least one axially inclined rib.

14. The use of a filter assembly according to claim 1 for filtering effluent of a washing machine.

15. A washing machine comprising a filter assembly according to claim 1.
